(19) United States
(12) Patent Application Publication
(10) Pub. No.: US 2006/0290967 A1
(43) Pub. Date: Dec. 28, 2006

(54) Image processing system and apparatus and approval server

(76) Inventors: Takaaki Sumitomo, Yokohama-shi (JP); Ayumi Segi, Yokohama-shi (JP); Takashi Ohsawa, Yokohama-shi (JP)

Correspondence Address: GAUTHIER & CONNORS, LLP, 225 FRANKLIN STREET, SUITE 2300, BOSTON, MA, 02110, US

(21) Appl. No.: 11/264,581

(22) Filed: Nov. 1, 2005

(30) Foreign Application Priority Data
Jun. 24, 2005 (JP) 2005-184329

(51) Int. Cl. G06K 15/00

(52) U.S. Cl. 358/1.14

(57) ABSTRACT

An image processing apparatus relating to the present invention outputs a document, which a user has commanded for output, and includes a rule storage section that stores an approval rule to determine a document which requires approval to be output, and information of an authorizer who determines whether or not to give approval, and an output control section that performs a control operation so that the document is not output until the authorizer approves the output of the document, when the document which is a target of the instruction of output is the document which requires approval to be output.

### BACKGROUND OF THE INVENTION

1. Field of the Invention

The present invention relates to an image processing apparatus, such as a copier, multifunction machine, printer, facsimile machine or scanner, for generating and outputting an image of a specified document, and to an output restriction for a document that requires restrictions on being printed or output in another form.

2. Description of the Related Art

The following related technique on restricting the document output in an image processing apparatus, such as a copier, is known. Namely, in this related technique, when a user inputs a user name and a password, the image processing apparatus performs an inquiry of an electronic authentication system, and if it is determined as a result of the inquiry that the user is authorized to perform copying or reading of the document, the operations are permitted.

In another related technique, the following method is used to prevent the copying of in-house confidential documents on an image processing apparatus, such as a copier. Namely, in this technique, a mark is added with a yellow toner having low visibility on a recording paper during the creation of a confidential document. If that mark is read during a copying process, the document is considered to be a confidential document and a security protection process, such as the output of a completely blackened sheet of paper, is performed. Furthermore, a known technique permits a stamped imprint to be registered in the image processing apparatus so that if the image processing apparatus reads the stamped imprint from a document, the document is considered to be a confidential document and the security protection process is performed. Moreover, another known technique forces the suspension of any process when an attempt is made to copy a confidential document and also adds and outputs a message, such as “this document is confidential and cannot be copied”, onto the paper by a developing unit in the next process.

Furthermore, a known e-mail transmission apparatus also prohibits the transmission of e-mail if the document itself includes a specific keyword and the destination includes a predetermined address.

There are many types of confidential documents and the degree as to the need for inhibiting an output operation, such as printing or copying, depends on the type of the document. For example, the viewing of some in-house confidential documents on a screen is permitted although printing to paper is completely forbidden, while the output of other documents, such as printing to paper, is permitted if approval is obtained from an authorizer. However, the above-mentioned techniques cannot control the output in detail in accordance with the degree as to the need to inhibit an output operation and can only inhibit the output of a document if the document to be output conflicts with a predetermined condition.

### SUMMARY OF THE INVENTION

According to an aspect of the invention, there is provided an image processing apparatus for outputting a document according to an instruction from a user. The image processing apparatus includes a rule storage section that stores an approval rule to determine a document which requires approval to be output, and information of an authorizer who determines whether or not to give approval, and an output control section that performs a control operation so that the document is not output until the authorizer approves the output of the document, when the document which is a target of the instruction of output is the document which requires approval to be output.

According to another aspect of the invention, there is provided an image processing system for outputting a document according to an instruction from a user. The image processing system includes a rule storage section that stores an approval rule to determine a document which requires approval to be output, and information of an authorizer who determines whether or not to give approval, and an output control section that performs a control operation so that the document is not output until the authorizer approves the output of the document, when the document which is a target of the instruction of output is the document which requires approval to be output.

According to another aspect of the invention, there is provided an image processing system having an image processing apparatus that outputs a document according to an instruction from a user, and an approval server. The image processing apparatus includes an inquiry section that inquires to the approval server whether output of a document requires approval, and an output control section that outputs the document when receiving response indicating that output of the document does not require approval, and performs a control operation so that the document is not output until approval is obtained when receiving response indicating that output of the document require approval. The approval server includes a rule storage section that stores an approval rule to determine a document which requires approval to be output, and information of an authorizer who determines whether or not to give approval, a response section that receives inquiry regarding if the document requires approval to be output from an image processing apparatus, and responses to the image processing apparatus based on the stored rule and information, and an approval processing section that informs the user or the image processing apparatus, if output of the document requires approval, that output of the document has been approved when approval is obtained.

According to another aspect of the invention, there is provided an image processing apparatus for outputting a document according to an instruction from a user. The image processing apparatus includes an inquiry section that inquires to the approval server whether output of a document requires approval, and an output control section that outputs the document when receiving response indicating that output of the document does not require approval, and performs a control operation so that the document is not output until approval is obtained when receiving response indicating that output of the document require approval.

According to another aspect of the invention, there is provided an approval server. The approval server includes a rule storage section that stores an approval rule to determine a document which requires approval to be output, and information of an authorizer who determines whether or not to give approval, a response section that receives inquiry regarding if the document requires approval to be output from an image processing apparatus, and responses to the image processing apparatus based on the stored rule and information, and an approval processing section that informs the user or the image processing apparatus, if output of the document requires approval, that output of the document has been approved when approval is obtained.

### BRIEF DESCRIPTION OF THE DRAWINGS

Embodiments of the present invention will be described in detail based on the following figures, wherein:

FIG. 1 is a functional block diagram showing an example configuration of an image processing apparatus relating to the present invention;

FIG. 2 shows an example of approval rules;

FIG. 3 is a functional block diagram showing an example configuration of an image processing apparatus relating to the present invention;

FIG. 4 shows an example display of a UI screen for approval processing;

FIG. 5 illustrates a modified example in which an authorizer can be individually registered for each approval rule;

FIG. 6 illustrates a modified example in which an authorizer can be individually registered for each security level for approval rules; and

FIG. 7 is a functional block diagram showing a modified image processing system.

### DETAILED DESCRIPTION OF THE INVENTION

Embodiments of the present invention will be described with reference to the attached drawings.

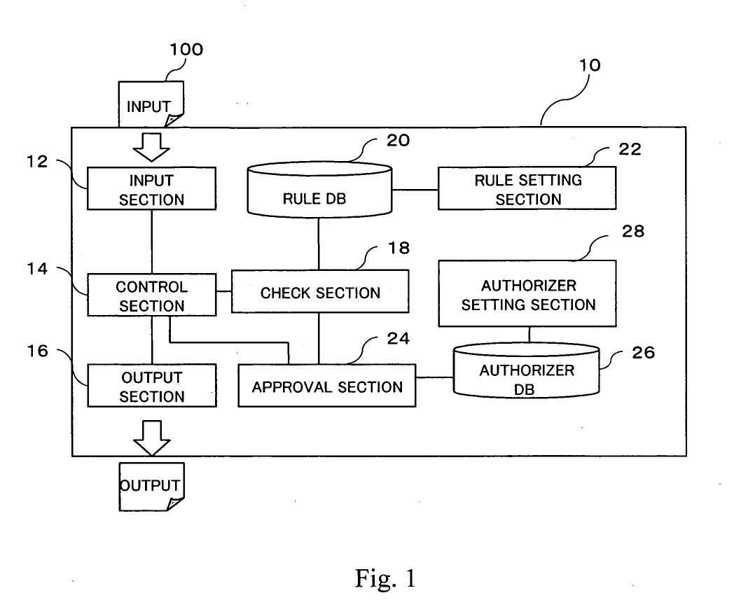

The configuration of an image processing apparatus 10 of this embodiment will be described with reference to FIG. 1. In this example, the image processing apparatus 10 is a copier, printer, scanner or facsimile machine, or a multifunction machine combining these functions. However, this is only one example. The image processing apparatus 10 may be any one of these apparatuses, such as a copier or a printer.

In the image processing apparatus 10, an input section 12 receives an input document 100 to be processed. For example, if the image processing apparatus 10 is a copier, scanner or facsimile machine, the input document 100 is a paper document, which is read by the input section 12 or image reading unit. In this case, the input section 12 transfers the image data of the document that was read to a control section 14. Furthermore, if the image processing apparatus 10 is a printer, the input document 100 is document data, such as that expressed in a page description language or in the form of image data, and the input section 12 receives the data from a client computer. In this case, the input section 12 either transfers the input document data to the control section 14 or converts the document data to data in an image data format that can be processed by an output section 16 and then transfers it to the control section 14. In the case of a multifunction machine, both paper documents and document data are accepted as the input document 100.

The output section 16 outputs the processed result from the image processing apparatus for the input document 100 that was input by the input section 12. For example, if the image processing apparatus is a copier or a printer, the output section 16 is a printing unit for printing images onto paper. Furthermore, in the case of a facsimile machine, the output section 16 is a transmitting unit for facsimile transmissions of images. In the case of a scanner, the output section 16 stores a scanned image as a file into a non-volatile storage within the image processing apparatus 10 or transmits the file to a pre-registered computer. In the case of a multifunction machine, the output section 16 that corresponds to various functions is provided.

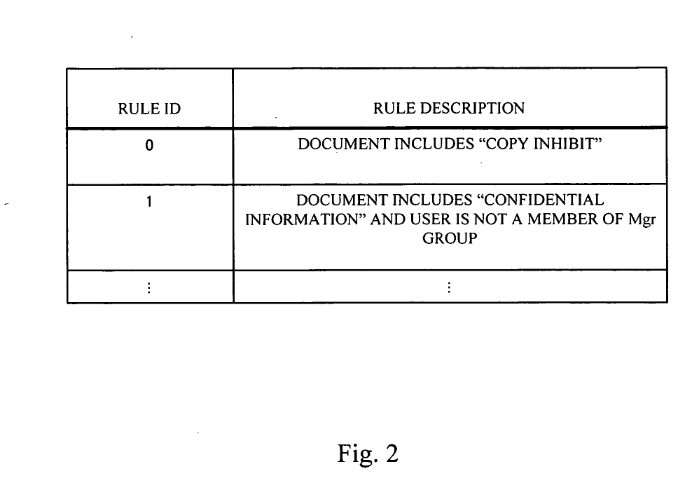

A check section 18 judges whether approval is required to output a document from the output section 16. This judgment is performed on the basis of approval rules registered in a rule DB (database) 20. An example of approval rules registered in the rule DB 20 is shown in FIG. 2. As shown in the figure, each rule is assigned a rule ID (identification information) and a rule description corresponding to the rule ID is registered. For example, the rule ID “0” represents a rule that requires approval for output of the document if a character string of “copy-inhibit” is included in the document body (or content part of the document and not “property” part thereof). Furthermore, rule ID “1” represents a rule that requires approval if a character string of “confidential information” is included in the document body and if the user who commanded the input of the document is not a member of an “Mgr” (manager) group. Here, information on a user who commands the copying or printing of a document is obtained from a user authentication process when using the image processing apparatus 10. User authentication can be performed using many methods, such as the input of user name and password (input from a local user interface (UI) of the image processing apparatus 10 or a UI of a driver program of a remote client) or the reading of a user held ID card utilizing magnetism or an IC chip. Although the approval rules illustrated hereinbefore utilized character strings within the document body or user information, the rules may be defined using various other types of information. For example, a rule judging the approval requirement may also be considered for images within the document body that contain a predetermined mark or predetermined stamped imprint. Furthermore, information items (for example, document author name or the destination for a facsimile transmission) in the property data attached to the document body can be incorporated into a rule. Moreover, if a condition regarding the document output mode (classification, such as copy, print, scan or facsimile transmission) can be described in a rule, a conditional setting becomes possible, such as requiring approval only for facsimile transmissions. The registration of a new rule or the deletion or modification of an existing rule in the rule DB 20 can be performed via a UI to be provided by a rule setting section 22.

The check section 18 judges whether there is a conflict with respect to each rule within the rule DB 20. If an input document is image data, such as a scanned image, a character string is read via OCR (optical character recognition) from the image and it is judged whether or not the character string conflicts any rule in the rule DB 20. A process is also performed to detect marks in the image, such as stamped imprints defined by rules. Furthermore, if the document was input as data in a page description language, a similar judgment may be performed on the character strings within the page description language data. Moreover, if a rule includes a condition relating to property or user information, the check section 18 performs a judgment using the property information attached to the document or user information obtained from a user authentication unit within the image processing apparatus 10.

An approval section 24 performs a process for accepting approval from an authorizer if it is judged that approval is required. The information on the authorizer (authentication information, such as user name and password) is registered in an authorizer DB 26. The information on authorizers who are registered in the authorizer DB 26 can be added, deleted, or modified via a UI that is provided by an authorizer setting section 28.

The approval section 24 includes the following type of processing, for example. Namely, if approval is required, the approval section 24 displays on a UI screen provided on the image processing apparatus 10, such as a liquid crystal touch panel, a message to the effect that approval is requested. An authorizer who sees this message logs in by performing user authentication for the image processing apparatus 10. When the person selects an approval task from a menu displayed on the UI screen, the approval section 24 displays a list of documents for which approval is requested from the authorizer. The list includes, for example, an ID assigned by the image processing apparatus 10 to each document, the file name (if it exists) of the document, the user name of the user who commanded the output, date and time of the output command, and so forth. Furthermore, the authorizer may be allowed to view the content of the document for which approval is being requested by performing an operation to display the images of the document on the UI screen (such as images of the document that have had their resolution converted for the UI screen). The authorizer selects documents from the list for which output is to be approved or rejected.

The control section 14 controls the various sections within the image processing apparatus 10, such as the input section 12, the output section 16, the check section 18, and the approval section 24. The control section 14 performs user authentication in accordance with a user login operation from a local UI section or a remote computer. When a document is input from the input section 12, the body data (image data or page description language data) and property data of the document and user information are transferred to the check section 18 and a check for approval requirement is requested. If, as a result, the check section 18 returns a response to the effect that approval is unnecessary, the control section 14 transfers the document data (such as image) to the output section 16 and an output operation is executed in accordance with a user specified output mode. On the other hand, if a response is returned indicating that approval is necessary, the control section 14 suspends the output process for the document and an approval process is requested from the approval section 24. At this time, a message to the effect that “the output process will be suspended until approval is obtained since the output of this document requires approval” is transferred to and displayed on the UI screen of the image processing apparatus 10 or the remote computer requesting the output. When the approval section 24 responds to this approval request to the effect that approval of the document output was received from the authorizer, the control section 14 resumes the suspended output process of the document and transfers the data for the document to the output section 16 for output. On the other hand, if a response arrives from the approval section 24 to the effect that the output of the document was rejected from the authorizer, the control section 14 transfers and displays a message on the local UI or the remote computer to the effect that “the current document could not be output since approval was rejected” and the data of the suspended document is destroyed. The process is then terminated without the document being output.

The control section 14, the check section 18, the approval section 24, and so forth, can be implemented by having the processor within the image processing apparatus 10 execute a program in which the functions of the respective sections are described.

In the case where it was judged that approval is required in the above-mentioned example, a message for the suspension of output or a message that approval was rejected is displayed on the UI screen or the screen of the remote computer. In addition, in the case where a user issues a command to copy or print from the UI of the image processing apparatus 10, the messages may be printed and output by the output section 16.

Although not shown, it is of course possible to register an output inhibit rule that indicates a condition for absolutely inhibiting the output with or without approval and to terminate the output of an input document (and to display or output a message indicating the reason for the output termination as necessary) if the output inhibit rule is applied.

As described above, according to this embodiment, for a document that can be output if there is approval from an appropriate authorizer, the image processing apparatus 10 suspends its output process and performs a process to accept the approval from the authorizer so that the output can be resumed when the approval is accepted. Therefore, instead of uniformly inhibiting the output of documents that conflict, with a rule, a detailed output control becomes possible where a document falling under an approval rule is set so that it can be output upon approval.

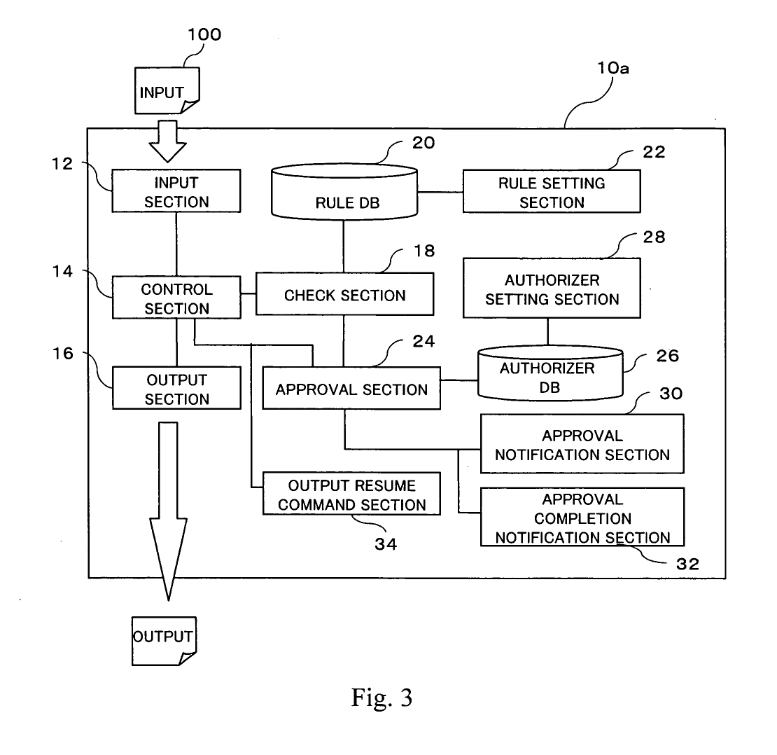

Next, a modified example will be described with reference to FIG. 3. The description of the components in FIG. 3 corresponding to the respective components shown in FIG. 1 and having like reference numerals in FIG. 1 will be omitted.

An image processing apparatus 10a in FIG. 3 adds an approval notification section 30, an approval completion notification section 32, and an output resume command section 34 to the image processing apparatus 10 of FIG. 1. In the above-mentioned embodiment, the approval process was performed using the local UI of the image processing apparatus 10. In comparison, this embodiment provides a mechanism for accepting an approval from an authorizer who is operating a remote computer.

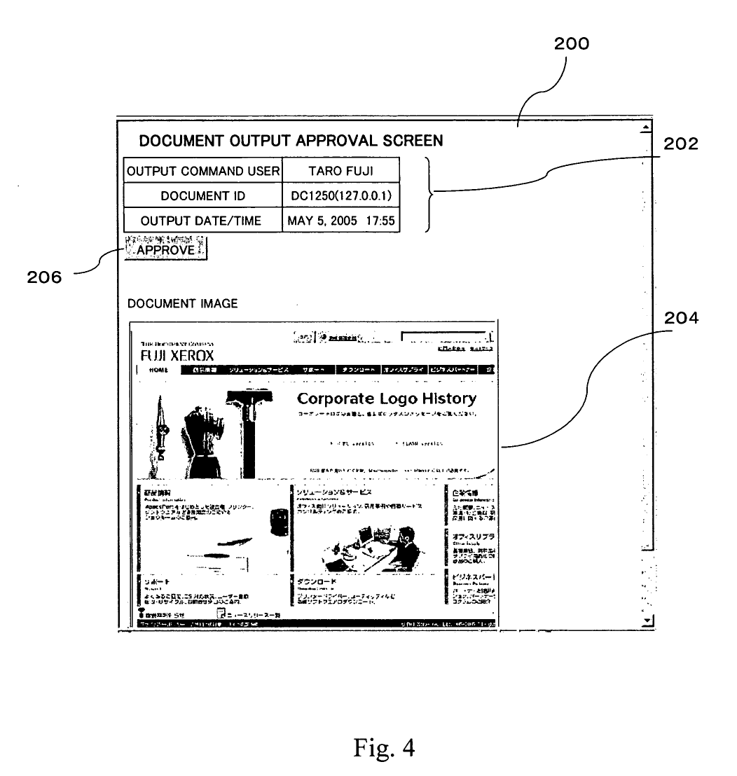

The approval notification section 30 creates notification information requesting approval from a remote authorizer and transmits the notification information addressed to the authorizer. The transmission of this notification information can be performed, such as through e-mail. The address information (for example, e-mail address) of the authorizer to be the destination of the notification is registered in advance in and then obtained from the authorizer DB 26 or a user information administration section within the image processing apparatus 10 or on a network. In addition to the function for the local approval process as described in the above-mentioned embodiment, the approval section 24 generates and provides a UI screen 200 for approval processing from a remote computer as shown in FIG. 4. This screen 200 includes property information 202 showing an object for approval, an image 204 in the document for approval (if there are multiple pages, either a representative page, such as the first page, or all pages may be displayed), and a GUI (graphical user interface) button 206 for indicating approval intent. The property information for approval includes, for example, identification information for the user who commands the output of the document, identification information of the image processing apparatus 10 on which the output command was issued, and the date and time when the output command was issued. Furthermore, a button for approval rejection may also be provided in addition to the button for approval. For example, one method is to equip the image processing apparatus 10 with a web server function and to provide the authorizer with the screen 200 as a web page. In this case, the notification information sent to the authorizer by the approval notification section 30 may be included with a message indicating that approval for document output is being requested and giving an URL for access to the UI screen 200 for approval processing. Instead of providing a screen for approval processing as a web page, notification information, which includes the property information 202 indicating what is to be approved or information (document name or document image) on the document to be approved and link information for approval or rejection, is created and provided to the authorizer. In this case, when the authorizer performs an operation, such as clicking on a link within the notification information, data showing approval or rejection is sent to the approval section 24 via a network using HTTP or other protocol.

When a command for approval or rejection is received from the authorizer, the approval section 24 records the approval result. Then, the approval completion notification section 32 sends a notification (such as e-mail) that indicates the approval result to the user who commanded the output of the document. The notification destination address of the user is obtained from a user information administration section within the image processing apparatus 10 or on a network.

If the output of a document is approved, the notification by the approval notification section 30 includes a link (such as URL indicating the ID of the document) to release the suspension of output for the document. When the user selects the link within the notification, such as by a click operation, the suspend release command is transmitted to the image processing apparatus 10 via a network using a protocol, such as HTTP. At the image processing apparatus 10 that receives this, the output resume command section 34 judges from the record of the approval result whether or not the document, the output of which the suspension release command indicates is to be released, has already been approved, and the control section 14 commands the output section 16 to output the document if approval has been obtained. In the link information of the notification that the approval completion notification section 32 sends to the user, information to the effect that approval was obtained is included together with the document ID, and the information to the effect that approval was obtained may be sent together with the document ID from the user's computer to the image processing apparatus 10. Furthermore, a character string, such as the ID of the approved document, is included in the notification that is sent from the approval completion notification section 32 to the user, and the user who views the notification proceeds to the image processing apparatus 10 and inputs the document ID through the UI of the image processing apparatus 10 so as to issue a command to release the output suspension state.

According to the modification of FIG. 3, a series of operations relating to approval can be performed by an authorizer or a user who executed an output command even if that person is not in proximity to the image processing apparatus 10.

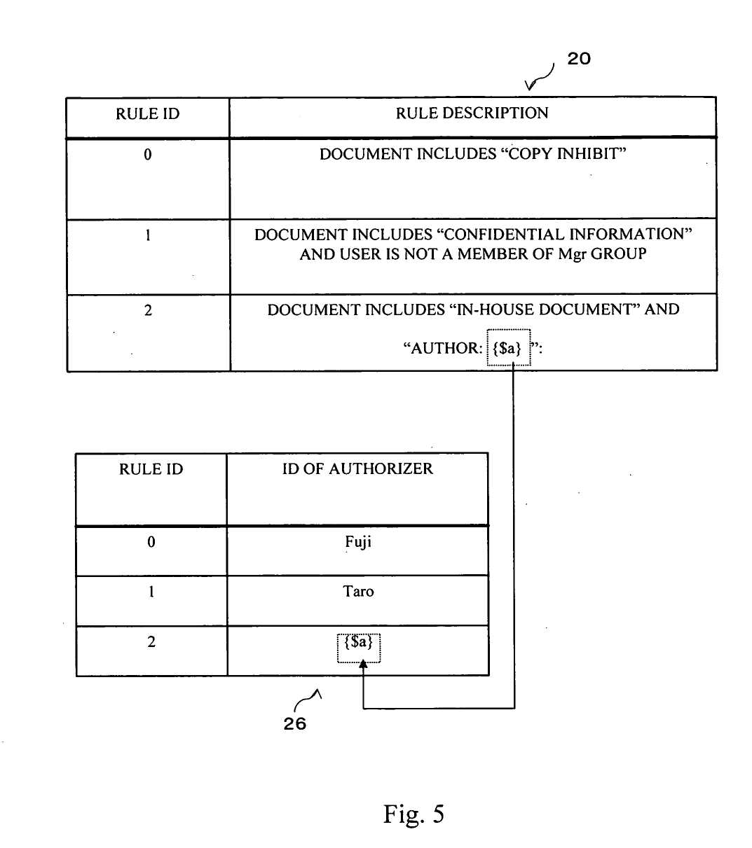

Next, another modification will be described with reference to FIG. 5. In this modification, an authorizer is individually registered for each approval rule. In the example of FIG. 5, information (such as an ID) on the authorizer is mapped to a rule ID of each rule within the rule DB 20 and registered in the authorizer DB 26. The approval section 24 and the approval notification section 30 obtain the authorizer from the authorizer DB 26 corresponding to the rule that the document conflicts with and request approval from that authorizer.

The rule having rule ID “2” in the example of FIG. 5 is a rule where approval is required if the document body includes “in-house document” and “author: {$a}” (variable to substitute for the character string following the character string of “author:”). The authorizer corresponding to this rule is the author of the document. Namely, with this rule, the document cannot be output until approval is obtained from the author indicated within the document.

According to this modification, a more detailed approval becomes possible since an appropriate authorizer can be specified for each approval rule.

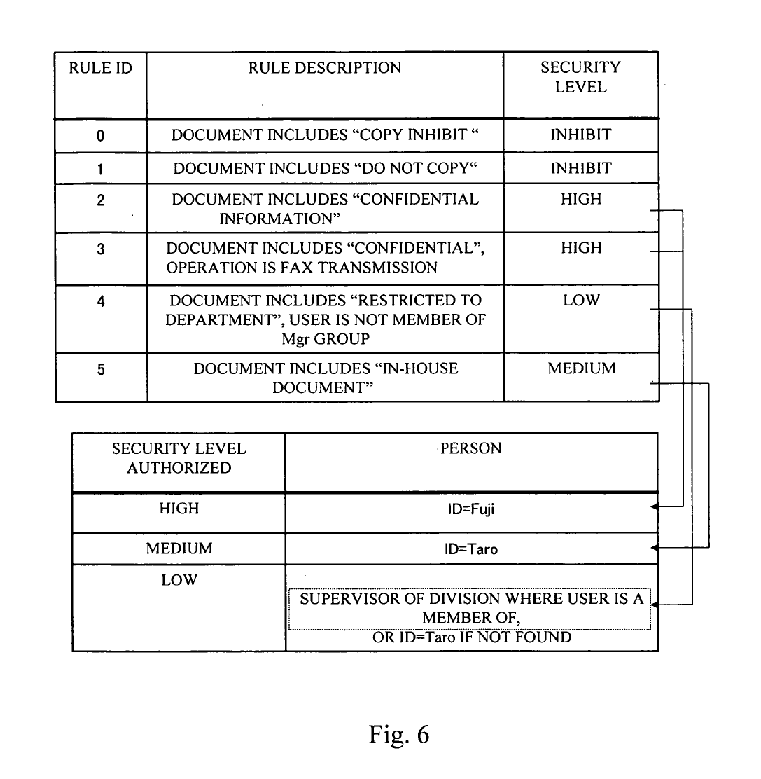

Another modification will be described with reference to FIG. 6. Compared to the modification of FIG. 5 where an authorizer is registered for every approval rule, the modification of FIG. 6 shows that a security level is set for each rule in the rule DB 20 and an authorizer is registered for every security level in the authorizer DB 26.

In this example, rules with rule IDs “0” and “1” have a security level of “inhibit” and the level of “inhibit” absolutely inhibits any output (regardless of the presence or absence of approval). If a document corresponds to the “inhibit” level, the control section 14 terminates the output of the document without requesting the approval process from the approval section 24. Furthermore, an authorizer for the security level of “low” is first a supervisor of the division of the user who commanded the output and this can be obtained from a user administration section (this also holds division and job position information on each user) located within the image processing apparatus 10 or on a network. Moreover, if the supervisor of the section in the division of the user is not determined from information on the user administration section, user “Taro” becomes the authorizer.

According to this modification, approval can be obtained from an appropriate authorizer in accordance with the degree of confidentiality of the document corresponding to an approval rule.

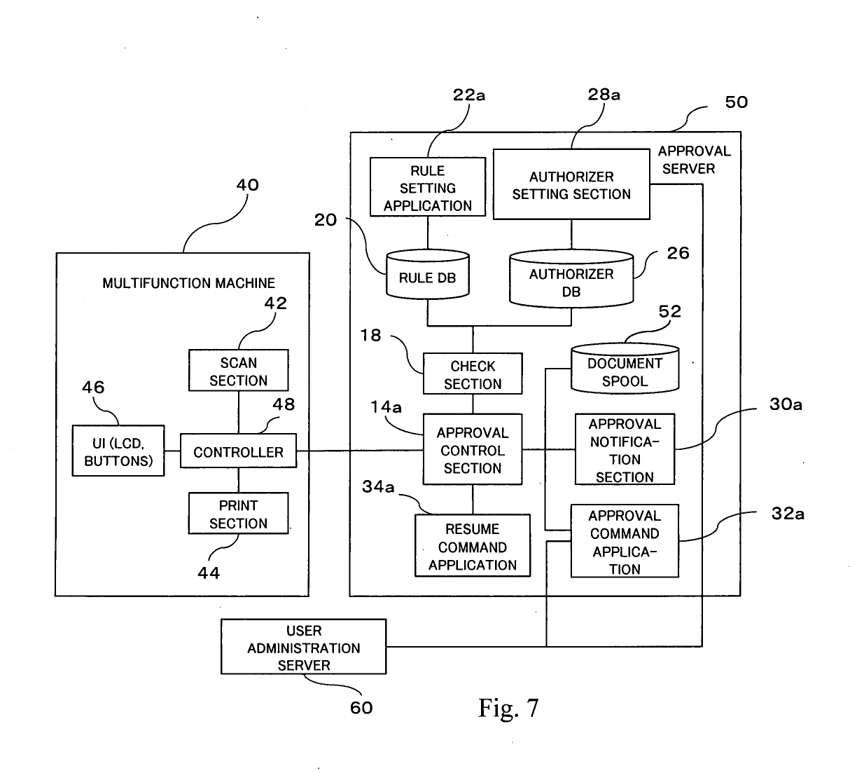

Yet another modification will be described with reference to FIG. 7.

Examples were given hereinbefore where the present invention was applied to the image processing apparatus 10 as a single unit. Compared to this, in the modification of FIG. 7, the system configuration provides the function of the approval process as an approval server 50 apart from the image processing apparatus (a multifunction machine 40 in FIG. 7). In FIG. 7, identical parts shown in FIGS. 1 and 3 are assigned identical reference characters and their descriptions will be omitted. The processing flow in various states in the system will be described in sequence hereinafter.

Setting a Rule and an Authorizer

1. The administrator of the approval server 50 sets a rule in advance for a document requiring approval for output in the rule setting application (program) 22a. The rule setting application 22a may provide a local user interface for rule setting at the approval server 50 or such a user interface at a remote computer, such as in the form of a web service. In this respect, this also applies to an authorizer setting section 28a, an approval command application 32a, and a resume command application 34a to be mentioned hereinafter.
2. The rule setting section 22a registers the set rule into the rule DB 20.
3. An administrator of the approval server 50 uses the authorizer setting section 28a to set an authorizer requesting approval for every set rule or for every security level of each rule when a document corresponding to the rule is detected. The authorizer selects users managed by a user administration server 60. The user administration server 60 (example: Microsoft's ActiveDirectory) provides user authentication services for the multifunction machine 40 and manages user information, such as user ID, password, name, e-mail address, division, and job position.
4. The authorizer setting section 28a registers pairs of rule IDs and IDs of authorizer corresponding to the rules (or pairs of security levels and IDs of authorizers) into the authorizers DB 26. The authorizer ID is the user ID of the authorizer that is managed by the user administration server 60.
   Copying and Approval-Required Judgment Process
5. Before a user executes a copy operation, a user name (user ID) and a password are input through a UI 46 of the multifunction machine 40.
6. A controller 48 sends the user name and password to the user administration server 60 and requests user authentication processing.
7. When the user is authenticated by the user administration server 60, the multifunction machine 40 allows that user to perform an operation, such as copying.
8. The user places a document to be copied on the scan section 42 and issues a copy operation using the UI 46.
9. The controller 48 commands the scan section 42 to scan the document.
10. The scan section 42 scans the document and sends the document data created by the scan to the controller 48.
11. The controller 48 inquires of the approval control section 14a of the approval server 50 as to whether the document can be output without approval. During the inquiry, information on the user who executed the output command and information on the multifunction machine 40 itself are transmitted in addition to the document data.
12. The approval control section 14a inquires of the check section 18 as to whether the output of the document requires approval. At this time, information on the user who executed the output command and information on the multifunction machine 40 itself are transferred to the check section 18 in addition to the document data.
13. The check section 18 compares the document data and user information sent from the approval control section 14a with the rules held in the rule DB 20, judges whether or not output is possible without approval, and returns the result of the judgment to the approval control section 14a. If there is no conflict with any rule, it is judged that output is possible without approval.
14. The authorizer DB 26 holds a rule ID (or security level) and the corresponding ID of the authorizer so that when the check section 18 judges that the output of a document requires approval, the ID of the authorizer is acquired from the authorizer DB 26 and the ID of the authorizer is also returned to the approval control section 14a together with the judgment result.
15. If a judgment of “output is possible without approval” is returned from the check section 18, the approval control section 14a transmits an output resume command to the controller 48 of the multifunction machine 40.
16. When the controller 48 receives the output resume command, an output command is provided to the print section 44 together with the document data. In response, the print section 44 performs output of the document data and then the process terminates.
17. If a judgment of “output requires approval” is returned from the check section 18, the approval control section 14a transmits an output suspension command for the document to the controller 48 of the multifunction machine 40. At this time, the controller 48 destroys the corresponding document data.
18. The controller 48 presents a message on a display screen of the UI 46 conveying that the copying of the document has been suspended until approval is obtained from the authorizer.
19. The approval control section 14a uses the ID of the authorizer sent together with the judgment result from the check section 18 to acquire the required information, such as the mail address of the authorizer, from the user administration server 60.
20. The approval control section 14a temporarily stores document data, information on the user executing the copy, information on the authorizer, and multifunction machine information to a document spool 52 until the approval process terminates. At this time, a unique document ID is assigned to the stored document and mapped to the document data and registered in the document spool 52.
21. The approval control section 14a commands a transmission to the approval notification section 30a of a notification for requesting approval processing to the authorizer. At this time, the document data, user information, and information on the authorizer are transferred together.
22. The approval notification section 30a creates an e-mail for requesting approval processing on the basis of data transferred from the approval control section 14a and sends it to the mail address of the authorizer. The process is once terminated until the authorizer accesses the approval command application 32a.
   Approval Command Processing
23. The authorizer who received an approval request accesses the approval command application 32a.
24. The approval command application 32a displays a login screen.
25. The authorizer inputs a user name and a password at the login screen.
26. The approval command application 32a requests user authentication processing from the user administration server 60.
27. When the user is authenticated by the user administration server 60, the approval command application 32a acquires document data to be approved by the authorizer and information attached to the document (such as user information, multifunction machine information) from the document spool 52 through the approval control section 14a.
28. The approval command application 32a presents document data and attached information to the authorizer and provides a user interface through which the authorizer is to approve or reject the output of the document. A screen display example of this user interface is similar to that shown in FIG. 4.
29. When the authorizer indicates approval or rejection through the user interface, the approval command application 32a notifies the approval control section 14a of the command by the authorizer.
30. The approval control section 14a acquires the mail address of the user from the user administration server 60 on the basis of user information attached to the document data.
31. The approval control section 14a commands the approval notification section 30a to transmit a notification of the approval result to the user. At this time, the document data, user information, and information on the authorizer are transferred together.
32. The approval notification section 30a creates mail for notifying the user of the approval result and transmits this mail to the mail address of the user. If the authorizer approves the output of the document, the mail includes the document ID.
   Document Output Resume Command
33. The user who received the notification executes the document output resume command. The user inputs the document ID that is included in the notification into the document output resume command application 34a or the UI 46 of the multifunction machine 40.
34. If the document resume command is performed with respect to the document output resume command application 34a, the document output resume command application 34a transfers the document ID that was input by the user to the approval control section 14a.
35. The approval control section 14a transfers the document ID to the controller 48 and commands the resumption of document output.
36. When the document output resume command from the approval control section 14a or the document output resume command from the UI 46 of the multifunction machine 40 is received, the controller 48 acquires the document data corresponding to the document ID from the document spool 52 through the approval control section 14a.
37. The controller 48 acquires document data from the approval server 50 and transfers it to the print section 44 and commands the output of document data. The print section 44 prints the document data.

In the system configuration described above, the data for the document awaiting approval accumulates in the document spool 52 of the approval server 50 so as to obviate the need for the multifunction machine 40 to store data awaiting approval and so that the hardware cost of the multifunction machine 40 can be reduced. Furthermore, the approval server 50 uses the document data stored in the document spool 52 on the user interface screen for setting approval, resulting in efficiency. For example, a system configuration is possible where one approval server 50 handles the control of the output inhibit and output approval for multiple multifunction machines 40 in an office.

Although an example of a copying operation was given in the above, similar control operations are also possible for the other output modes, such as print, scan, and facsimile transmission.

In the above-mentioned embodiments and modifications, after approval is obtained from the authorizer, the output operation is performed upon an output command (output suspension disable command) from a user who executed the output of a document. In this method, there is an advantage in that output is possible upon user acceptance. However, besides this, for example, the document may be output as soon as approval is obtained from the authorizer. In this case, after the document has been output, the image processing apparatus 10 or approval server 50 may notify the user, such as via e-mail, of the output.

Furthermore, in the above-mentioned embodiments and modifications, when a document, which the user has specified for output, simultaneously conflicts with multiple approval rules, approval is requested of all authorizers corresponding to the approval rules and the output of the document is permitted only after all approvals have been obtained. Moreover, if the document conflicts with even one rule that absolutely inhibits output, the output of the document is inhibited and a process for accepting the approval from an authorizer for another rule is not performed.

The approval server relating to the embodiments and modifications described above is implemented in a general-purpose computer system and the functions and operations of the above-mentioned approval server are implemented by executing the above-mentioned software. The program is ideally provided in recorded form on a computer-readable medium, for example, optical discs, such as CD-ROM and DVD-ROM, magnetic discs, such as flexible discs, or hard disk drives.

While there has been described what are at present considered to be preferred embodiments of the invention, it will be understood that various modifications may be made thereto, and it is intended that the appended claims cover all such modifications as fall within the true spirit and scope of the invention.

According to an aspect of the invention, there is provided an image processing apparatus for outputting a document according to an instruction from a user. The image processing apparatus includes a rule storage section that stores an approval rule to determine a document which requires approval to be output, and information of an authorizer who determines whether or not to give approval, and an output control section that performs a control operation so that the document is not output until the authorizer approves the output of the document, when the document which is a target of the instruction of output is the document which requires approval to be output.

According to another aspect of the invention, the output control section may transmit a notice, when the approval is obtained, indicating that the output of the document has been approved to the user who has instructed to output the document.

According to another aspect of the invention, the notice that is sent to the user may include command information for commanding the output of the document, and the document is output when an instruction of output based on the commanding information from the user is received.

According to another aspect of the invention, the output control section, if the document which is the target of the instruction of output is the document which requires approval, may transmit information of the requested approval and image of the document to the authorizer.

According to another aspect of the invention, the rule storage section may store a plurality of approval rules and information of an authorizer corresponding to each approval rule, and the output control section may control so that the document is not output until the authorizer corresponding to the approval rule approves the output of the document.

According to another aspect of the invention, the rule storage section may stores information of a security level for each rule, information of an authorizer may correspond to each security level, and the output control section may perform a control operation so that the document is not output until approval is obtained from the authorizer corresponding to the security level of the rule.

According to another aspect of the invention, there is provided an image processing system for outputting a document according to an instruction from a user. The image processing system includes a rule storage section that stores an approval rule to determine a document which requires approval to be output, and information of an authorizer who determines whether or not to give approval, and an output control section that performs a control operation so that the document is not output until the authorizer approves the output of the document, when the document which is a target of the instruction of output is the document which requires approval to be output.

According to another aspect of the invention, there is provided an image processing system having an image processing apparatus that outputs a document according to an instruction from a user, and an approval server. The image processing apparatus includes an inquiry section that inquires to the approval server whether output of a document requires approval, and an output control section that outputs the document when receiving response indicating that output of the document does not require approval, and performs a control operation so that the document is not output until approval is obtained when receiving response indicating that output of the document require approval. The approval server includes a rule storage section that stores an approval rule to determine a document which requires approval to be output, and information of an authorizer who determines whether or not to give approval, a response section that receives inquiry regarding if the document requires approval to be output from an image processing apparatus, and responses to the image processing apparatus based on the stored rule and information, and an approval processing section that informs the user or the image processing apparatus, if output of the document requires approval, that output of the document has been approved when approval is obtained.

According to another aspect of the invention, the approval server may further include a spool section that stores data of the document, and the approval processing section of the approval server may transmit information of required approval and image of the document if output of the document requires approval, and provide the document data stored in the spool section to the image processing apparatus when approval is obtained.

According to another aspect of the invention, there is provided an image processing apparatus for outputting a document according to an instruction from a user. The image processing apparatus includes an inquiry section that inquires to the approval server whether output of a document requires approval, and an output control section that outputs the document when receiving response indicating that output of the document does not require approval, and performs a control operation so that the document is not output until approval is obtained when receiving response indicating that output of the document require approval.

According to another aspect of the invention, there is provided an approval server. The approval server includes a rule storage section that stores an approval rule to determine a document which requires approval to be output, and information of an authorizer who determines whether or not to give approval, a response section that receives inquiry regarding if the document requires approval to be output from an image processing apparatus, and responses to the image processing apparatus based on the stored rule and information, and an approval processing section that informs the user or the image processing apparatus, if output of the document requires approval, that output of the document has been approved when approval is obtained.

According to another aspect of the invention, the rule storage section may store a rule to determine a document of which output is inhibited.

According to another aspect of the invention, the information transmitted to the authorizer may include an image data which is displayed on a screen of a computer of the authorizer and used to input the result of determination whether or not to give approval to output of the document.

The entire full disclosure of Japanese Patent Application No. 2005-184329 filed on Jun. 24, 2005, including the specification, claims, drawings and abstract, is incorporated herein by reference in its entirety.

What is claimed is:

1. An image processing apparatus for outputting a document according to an instruction from a user, the image processing apparatus comprising:
a rule storage section that stores an approval rule to determine a document which requires approval to be output, and information of an authorizer who determines whether or not to give approval; and
an output control section that performs a control operation so that the document is not output until the authorizer approves the output of the document, when the document which is a target of the instruction of output is the document which requires approval to be output.

2. The image processing apparatus according to claim 1, wherein:
the output control section transmits a notice, when the approval is obtained, indicating that the output of the document has been approved to the user who has instructed to output the document.

3. The image processing apparatus according to claim 2, wherein:
the notice that is sent to the user includes command information for commanding the output of the document, and the document is output when an instruction of output based on the commanding information from the user is received.

4. The image processing apparatus according to claim 1, wherein:
the output control section, if the document which is the target of the instruction of output is the document which requires approval, transmits information of the requested approval and image of the document to the authorizer.

5. The image processing apparatus according to claim 1, wherein:
the rule storage section stores a plurality of approval rules and information of an authorizer corresponding to each approval rule; and
the output control section controls so that the document is not output until the authorizer corresponding to the approval rule approves the output of the document.

6. The image processing apparatus according to claim 1, wherein:
the rule storage section stores information of a security level for each rule;
information of an authorizer corresponds to each security level; and
the output control section performs a control operation so that the document is not output until approval is obtained from the authorizer corresponding to the security level of the rule.

7. An image processing system for outputting a document according to an instruction from a user, the image processing system comprising:
a rule storage section that stores an approval rule to determine a document which requires approval to be output, and information of an authorizer who determines whether or not to give approval; and
an output control section that performs a control operation so that the document is not output until the authorizer approves the output of the document, when the document which is a target of the instruction of output is the document which requires approval to be output.

8. An image processing system comprising an image processing apparatus that outputs a document according to an instruction from a user, and an approval server;
wherein the image processing apparatus comprises:
an inquiry section that inquires to the approval server whether output of a document requires approval; and
an output control section that outputs the document when receiving response indicating that output of the document does not require approval, and performs a control operation so that the document is not output until approval is obtained when receiving response indicating that output of the document require approval;
wherein the approval server comprises:
a rule storage section that stores an approval rule to determine a document which requires approval to be output, and information of an authorizer who determines whether or not to give approval;
a response section that receives inquiry regarding if the document requires approval to be output from an image processing apparatus, and responses to the image processing apparatus based on the stored rule and information; and
an approval processing section that informs the user or the image processing apparatus, if output of the document requires approval, that output of the document has been approved when approval is obtained.

9. The image processing system according to claim 8, wherein:
the approval server further comprises a spool section that stores data of the document; and
the approval processing section of the approval server transmits information of required approval and image of the document if output of the document requires approval, and provides the document data stored in the spool section to the image processing apparatus when approval is obtained.

10. An image processing apparatus for outputting a document according to an instruction from a user, the image processing apparatus comprising:
an inquiry section that inquires to the approval server whether output of a document requires approval; and an output control section that outputs the document when receiving response indicating that output of the document does not require approval, and performs a control operation so that the document is not output until approval is obtained when receiving response indicating that output of the document require approval.

11. An approval server comprising:
a rule storage section that stores an approval rule to determine a document which requires approval to be output, and information of an authorizer who determines whether or not to give approval;
a response section that receives inquiry regarding if the document requires approval to be output from an image processing apparatus, and responses to the image processing apparatus based on the stored rule and information; and an approval processing section that informs the user or the image processing apparatus, if output of the document requires approval, that output of the document has been approved when approval is obtained.

12. The image processing apparatus according to claim 1, wherein
the rule storage section stores a rule to determine a document of which output is inhibited.

13. The image processing apparatus according to claim 4, wherein
the information transmitted to the authorizer includes an image data which is displayed on a screen of a computer of the authorizer and used to input the result of determination whether or not to give approval to output of the document.
